(19) United States
(12) Patent Application Publication
(10) Pub. No.: US 2025/0125334 A1
(43) Pub. Date: Apr. 17, 2025

(54) RECHARGEABLE LITHIUM CELLS WITH PRE-LITHIATED CATHODE

(71) Applicant: Pacific Industrial Development Corporation, Ann Arbor, MI (US)

(72) Inventors: Bing Tan, Ann Arbor, MI (US); Yuhao Liao, Ann Arbor, MI (US); Andrew Rajewski, Clinton, MI (US); Wei Wu, Ann Arbor, MI (US)

(21) Appl. No.: 18/702,101

(22) PCT Filed: Oct. 12, 2022
(86) PCT No.: PCT/US2022/046361

§ 371 Date: Apr. 17, 2024

Related U.S. Application Data
(60) Provisional application No. 63/275,054, filed on Nov. 3, 2021.

(51) Int. Cl. H01M 4/131; H01M 4/02; H01M 4/133; H01M 4/36; H01M 4/505; H01M 4/66; H01M 10/0565

(52) U.S. Cl. CPC H01M 4/131; H01M 4/133; H01M 4/364; H01M 4/505; H01M 4/661; H01M 4/662; H01M 10/0565; H01M 2004/027; H01M 2004/028; H01M 2220/20; H01M 2300/0085

(57) ABSTRACT

A cell for use in an electrochemical cell, that includes a positive electrode having a current collector, a pre-lithiated active cathode material according to the formula F-1 of Li₁₊ₓMn₂O₄, wherein x is in the range of 0.1 to 1.0, and an optional additional active cathode material; a negative electrode having a current collector and an optional carbonaceous material that exhibits a negligible capacity, wherein negligible capacity is defined as being a reversible capacity ratio between the carbonaceous material and the pre-lithiated active cathode material of <0.1.; and a non-flammable organic electrolyte, a polymeric or gel electrolyte, an inorganic electrolyte, or a combination thereof that is configured to conduct lithium ions.

### CROSS-REFERENCE TO RELATED APPLICATIONS

This application claims the benefit of the filing date under 35 U.S.C. § 119(e) of U.S. Provisional Application No. 63/275,054 filed Nov. 3, 2021, the entire contents of which is hereby incorporated herein by reference.

### FIELD

This invention generally relates to rechargeable batteries. More specifically, the present disclosure describes an “anode-free” design of an electrochemical cell for use in a rechargeable battery.

### BACKGROUND

The statements in this section merely provide background information related to the present disclosure and may not constitute prior art.

Electric vehicles (EV) are becoming the generation of vehicles that may replace vehicles powered with an Internal Combustion Engine (ICE). The main component in an electric vehicle (EV) is its battery. This battery accounts for a significant proportion of the cost, mileage, and safety exhibited by the vehicle. In order to provide the necessary amount of energy, the battery used in an EV generally comprises multiple cells. In many cases, the number of cells used in a battery may range up to hundreds of cells or even thousands of cells. In order to extend the distance or mileage that the vehicle may incur prior to requiring recharging and to increase the overall safety of the vehicle, it is necessary to enhance the energy density and the safety of the battery at the individual cell level.

The conventional lithium ion cell used in an EV application incorporates an anode (e.g., graphite, etc.) a cathode (e.g., lithium metal oxide/phosphate, etc.) and an organic electrolyte containing LiPF₆. One issue with conventional cells is that they may cause a fire during a thermal runaway situation, mainly resulting from the interaction between the organic electrolyte and the graphite anode. In addition, since the active graphite material used in the anode exhibits a limited amount of specific capacity (i.e., theoretical=372 mAh/g), the energy density of the cell becomes restricted. In order to improve overall safety and increase energy density, the battery industry is interested in the development of lithium metal cells that use non-flammable electrolytes, including solid-state electrolytes. However, there are many challenges associated with the commercialization of this type of cell.

One of these challenges is the increased cost of using thin lithium foil as the anode in order to compensate for the lithium lost on the anode-side of the cell during cycling. These thin lithium foils, which are generally s 20 micrometers (μm), are difficult and expensive to produce because of their softness and the high reactivity of lithium metal.

In order to reduce the cost of production, it is necessary to avoid using thin lithium metal foil and instead use an “anode-free” design. However, cells with an “anode-free” design generally lack good cycling capacity because there is not any or at least insufficient lithium to continually replenish the lithium lost on the anode-side of the cell. Therefore, a continual need exists for the development of a low-cost, “anode-free” battery that can provide lithium to the anode current collector similar to the use of thin lithium foils in order to compensate for the lithium loss that occurs during cycling.

### SUMMARY

This disclosure relates generally to an “anode-free” design of an electrochemical cell for use in a rechargeable battery. This rechargeable electrochemical cell, comprises a positive electrode, a negative electrode, and a non-flammable electrolyte configured to conduct lithium ions. The positive electrode includes a current collector and a pre-lithiated active cathode material comprising one or more of Li₁₊ₓMn₂O₄, Li₁₊ₓNi_{0.5}Mn_{1.5}O₄, Li₁₊ₓNiO₂, Li₁₊ₓCoO₂, Li₁₊ₓNiₐCo_{b}Mn_{c}Al_{d}O₂, wherein x is in the range of 0.1 to 1.0; a+b+c+d=1; a≥0.5; 0≤b≤0.3; 0≤c≤0.3; and 0≤d≤0.05. The negative electrode includes a current collector and an optional material provided that the negative electrode exhibits negligible capacity. This cell may have an areal reversible cathode capacity loading ≥3.0 mAh/cm²; alternatively, 4.5 mAh/cm². When desirable, the active cathode material may include a range for x of 0.1 to 0.7; alternatively, 0.3 to 0.5 and/or the active cathode may the composition of Li₁₊ₓMn₂O₄.

The positive electrode may further comprise an additional active cathode material, such that the mixture of the pre-lithiated active cathode material and the additional active cathode material is in a mass ratio that ranges from greater than 100:0 up to less than or equal to 10:90; alternatively the mass ratio ranges from greater than 100:0 to 51:49.

The material of the current collector in the negative electrode may comprise Cu, Fe, Ni, or a mixture or alloy thereof. The current collector of one or more of the positive and negative electrodes includes silver, zinc, aluminum, gallium, or a combination thereof. In addition, the current collector of one or more of the positive and negative electrodes may include at least one metal that can form an alloy with lithium.

The optional material of the negative electrode may comprise a carbonaceous material in which the negligible capacity is defined as being a reversible capacity ratio between the optional material and the pre-lithiated active cathode material being ≤0.1.

The electrolyte may be a non-flammable organic electrolyte, a polymeric or gel electrolyte, an inorganic electrolyte, or a combination thereof. Alternatively, the electrolyte is a non-flammable gel electrolyte.

According to another aspect of the present disclosure, a battery pack for use in an electric vehicle is provided. This battery pack may comprise a plurality of cells as previously described above and as further defined herein. The plurality of cells may be placed in series or in a parallel configuration in order to increase overall capacity.

According to yet another aspect of the present disclosure, a rechargeable electrochemical cell is provided. this cell generally comprises a positive electrode that includes a current collector, a pre-lithiated active cathode material according to the formula F-1 of Li₁₊ₓMn₂O₄, wherein x is in the range of 0.1 to 1.0, and an optional additional active cathode material; a negative electrode that includes a current collector and an optional carbonaceous material that exhibits a negligible capacity, wherein negligible capacity is defined as being a reversible capacity ratio between the carbonaceous material and the pre-lithiated active cathode material of ≤0.1; and a non-flammable organic electrolyte, a polymeric or gel electrolyte, an inorganic electrolyte, or a combination thereof that is configured to conduct lithium ions.

The pre-lithiated active cathode material and the additional active cathode material may be in a mass ratio that ranges from greater than 100:0 up to less than or equal to 10:90. When desirable, the additional active cathode material may be LiMn₂O₄.

The current collector of one or more of the positive and negative electrodes in the cell may include at least one metal that can form an alloy with lithium. This cell may have an areal reversible cathode capacity loading ≥3.0 mAh/cm².

In this cell, the Li₁₊ₓMn₂O₄ is prepared by lithiating LiMn₂O₄ in an organic solvent with a pre-lithiation reagent. The pre-lithiation reagent may be lithium naphthalene or lithium iodide. In addition, this pre-lithiation reagent may have a reduction potential in the range of 0.3 V to 2.8 V vs. Li/Li*.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1A is a schematic representation of an electrochemical cell comprising an anode, a cathode, an electrolyte, and a separator;

FIG. 1B is a schematic representation of an electrochemical cell of an “anode-free” design according to the teachings of the present disclosure;

FIG. 1C is a schematic representation of another electrochemical cell according to the “anode-free design of the present disclosure;

FIG. 2 is a graphical comparison of the x-ray diffraction (XRD) patterns for pristine LiMn₂O₄ and the pre-lithiated Li_{1.3}Mn₂O₄ prepared and used according to the teachings of the present disclosure;

FIG. 3 is a graphical plot of voltage as a function of specific capacity for the 1^{st} charge/discharge cycle for cells containing pristine LiMn₂O₄ or pre-lithiated Li_{1.3}Mn₂O₄ cathodes according to the teachings of the present disclosure; and

FIG. 4 is a graphical plot of the cycling stability difference for “anode-free” cells containing prelithiated Li_{1.3}Mn₂O₄ and pristine LiMn₂O₄ cathodes according to the teachings of the present disclosure.

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

The following description is merely exemplary in nature and is in no way intended to limit the present disclosure or its application or uses. For example, the “anode-free” electrochemical cell prepared and used according to the teachings contained herein are described throughout the present disclosure as a battery cell for use in an electric vehicle (EV) in order to more fully illustrate the structural elements and the use thereof. The incorporation and use of such an “anode-free” electrochemical cell in other applications, including without limitation as a cell in another rechargeable battery, such as a “secondary cell” battery, is contemplated to be within the scope of the present disclosure.

As used herein a “battery cell” or “cell” refers to the basic electrochemical unit of a battery that contains the electrodes, separator, and electrolyte. In comparison, a “battery” or “battery pack” refers to a collection of cell(s), e.g., one or more cells, and includes a housing, electrical connections, and possibly electronics for control and protection.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

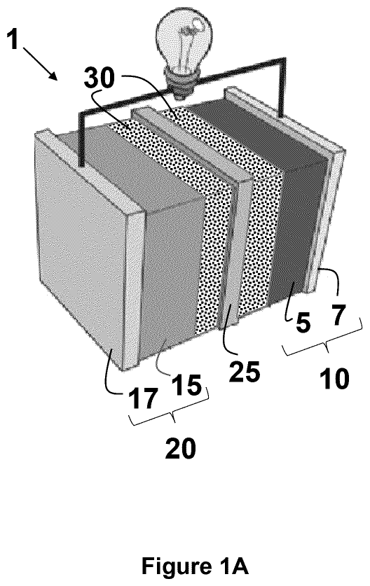

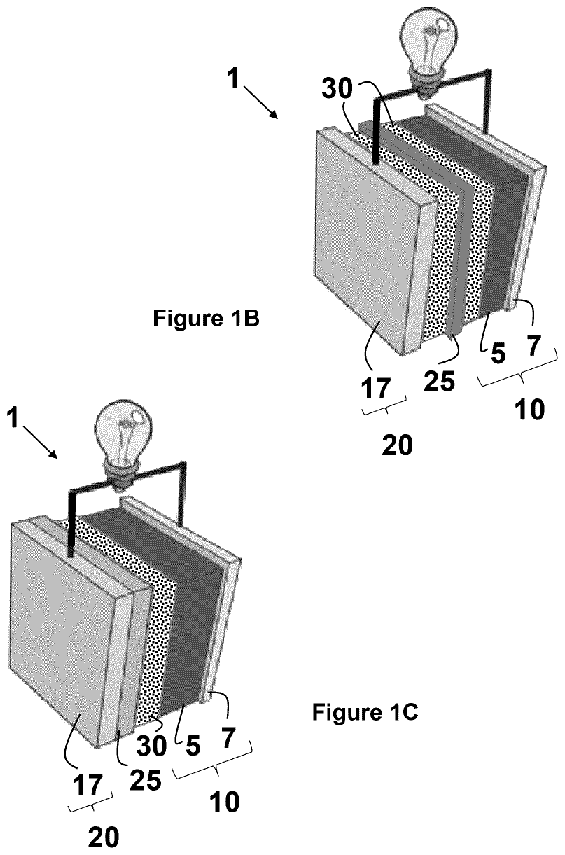

As shown in FIG. 1A, a conventional electrochemical cell 1, such as a secondary cell for a lithium-ion battery, generally comprises a positive electrode 10 including an active material (cathode) 5 and a current collector 7, a non-aqueous electrolyte 30 containing lithium ions, a separator 25, and a negative electrode 20 including an active material (anode) 15 and a current collector 17. All of these components are sealed in a case, an enclosure, a pouch, a bag, a cylindrical shell, or the like (generally called the battery's “housing”). The separator 25 electrically insulates the cathode 5 from the anode 15, while still allowing lithium ions to flow between them. The flow of ions may be conducted by the separator (i.e., via a solid-state mechanism) or by the presence of a liquid electrolyte 30 that permeates through the porosity of the separator 25 (e.g., a membrane).

The present disclosure generally provides the use of a pre-lithiated cathode active material in a rechargeable lithium cell that includes an “anode-free” design. Referring now to FIGS. 1B and 1C, in an anode-free design, the electrochemical cell 1 is made with a positive electrode 10 comprising a current collector 7 and an active material (cathode) 5, such as pre-lithiated LiMn₂O₄, while the negative electrode 20 side of the cell 1 generally includes only a current collector 17.

The current collector 7 in the positive 10 electrode may be made of any metal known in the art for use in an electrode of a lithium battery, such as for example, without limitation, aluminum, titanium, stainless steel, nickel, copper, carbon, zinc, gallium, silver, and combinations or alloys formed therefrom. The current collector 17 used in the negative electrode 20 may be a metallic foil that does not react with lithium ions. Several examples of such metallic foils may include, but not be limited to, Cu, Fe, Ti, Ni, Mo, W, Zr, Mn, carbon, and lithium metal alloys. Alternatively, the metallic foil for the current collector 17 of the negative electrode 20 comprises Cu, Fe, Ni, or a mixture or alloy thereof.

When desirable, the current collector 17 in the “anode-free” design may include an optional material, such that the resulting negative electrode 20 can react with lithium ions, provided the substrate formed from the optional material can maintain its shape and integrity during cycling and exhibits very low or negligible capacity. Several examples of such a substrate formed using the optional material include, without limitation, substrates formed with a carbonaceous material such as graphite, graphene, carbon nanotube, and carbon fibers that exhibit a low areal capacity loading, such that the optional material to active cathode material reversible capacity ratio is less than or equal to 1:10. If the optional material to the active cathode material capacity ratio is high, for example as 1:1, then the cell represents a more conventional graphite-like cell that includes an active anode material and provides no advantage with respect to volume and/or mass of the negative electrode side of the cell. A main benefit associated with an “anode-fee” cell is that it eliminates or at least significantly reduces the electrode volume and/or mass by not incorporating any pre-deposited anode active layer onto the current collector during the fabrication of the cell. This reduction in volume and/or mass is evident in a comparison of FIG. 1A with that of FIGS. 1B and 1C.

Still referring to FIGS. 1B and 1C, the active cathode material 5 of the positive electrode 10, generally comprises a pre-lithiated material comprising the chemical formula shown in F-1,

Li₁₊ₓMn₂O₄, (F-1)

wherein x is within the range of 0.1≤x≤1.0. The LiMn₂O₄ that is commercially available is generally formed to have a slight excess of lithium, typically up to 5% and always significantly less than 10% in order to compensate for the amount of lithium lost during the production process. In order for a pre-lithiated active cathode material 5 to be used in the “anode-less” cell 1 of the present disclosure the amount of excess lithium needs to be at least 10% or more. Only in this situation is an amount of excess lithium available for the anode that will improve or enhance the cycle life-time associated with the cell 1. This means that the amount of excess lithium in commercially available LiMn₂O₄ must be increased, e.g., such that x≥0.1 in formula F-1.

In addition to using a pre-lithiated active material according to formula F-1 (Li₁₊ₓMn₂O₄), other pre-lithiated lithium metal oxide materials may also be used either alone or in combination with the material of formula F-1 in the “anode-free” cell design without exceeding the scope of the present disclosure. These other pre-lithiated lithium metal oxide materials may include, but not be limited to, Li₁₊ₓNi_{0.5}Mn_{1.5}O₄, Li₁₊ₓNiO₂, Li₁₊ₓCoO₂, or Li₁₊ₓNiₐCo_{b}Mn_{c}Al_{d}O₂ (with x≥0.1; a+b+c+d=1; a≥0.5; 0≤b≤0.3; 0≤c≤0.3; and 0≤d≤0.05). The cell should have an areal reversible cathode capacity that is 3.0 mAh/cm²; alternatively, 4.5 mAh/cm².

The incorporation of between 10% to 100% of an excess amount of lithium in the pre-lithiated active cathode material 5 changes the crystal structure of the LiMn₂O₄ from spinel to tetragonal, which can be converted back to spinel during cycling. If the lithium content in the pre-lithiated active cathode material 5 is too high (i.e., x>1.0 in formula F-1), a non-tetragonal crystal phase will be formed that cannot be easily converted back to a spinel crystal phase during charging and the reversible capacity of the cell 1 will be reduced.

For “anode-free” cells 1, which contain pre-lithiated active cathode materials 5, such as those that correspond to the formula F-1, the Coulombic Efficiency (CE) may be theoretically calculated to be in the range of about 91% to 50% as shown below in Table 1. Due to the irreversible capacity lost during the 1^{st} cycle from side reactions that occur with the electrolyte, the actual CE for the “anode-free” cells 1 is expected to be slightly lower than the calculated theoretical values. An “anode-free” cell 1 formed using a pre-lithiated active cathode material having the composition of Li_{1.3}Mn₂O₄ prepared in a solution process exhibited a Coulombic Efficiency (CE) of 67%, which is about 10% lower than the calculated theoretical value.

TABLE 1
Theoretical calculations of the 1^{st} cycle CE for pre-lithiated
active cathode materials according to the formula
F-1: Li₁₊ₓMn₂O₄ (0.1 ≤ x ≤ 1.0)

| | | 1st charging | 1st discharge | |
|---|---|---|---|---|
| | Molecular | capacity | capacity | 1st |
| | weight | (mAh/g, | (mAh/g, | CE |
| Material | (g/mol) | calculated) | calculated) | (%) |
| LiMn₂O₄ | 180.8 | 148 | 148 | 100 |
| Li_{1.1}Mn₂O₄ | 181.5 | 162 | 148 | 91 |
| Li_{1.3}Mn₂O₄ | 182.9 | 191 | 147 | 77 |
| Li_{1.5}Mn₂O₄ | 184.3 | 218 | 145 | 67 |
| Li_{1.7}Mn₂O₄ | 185.7 | 245 | 144 | 59 |
| Li₂Mn₂O₄ | 187.7 | 286 | 143 | 50 |

As shown in Table 1, an increase in the lithium content for the active cathode material results in a decrease in the 1^{st} cycle CE. This loss in capacity results from the oxides that contain a high lithium content (e.g., x close to 1.0) are capable of readily absorbing moisture when stored in air. In this case, a moderate amount of lithium is preferred for use in the pre-lithiated active cathode material so that the material may be more easily processed. Thus, the amount of lithium in the pre-lithiated active cathode material is preferred to be in the range of 0.1≤x≤0.7; alternatively, and more preferably, in the range of 0.3≤x≤0.5.

The pre-lithiated active cathode material may be used alone as the active cathode material or it may be used in combination with another active cathode material. Several examples of such conventional active cathode materials include, without limitation, pristine LiMn₂O₄, LiFePO₄, LiFeₓMn_{y}PO₄ (i.e., x+y=1.0, 0.1≥x≤0.5, and 0.5≥y≤0.9), lithium nickel manganese cobalt oxides (NCM or Li-NCM), LiCoO₂, LiNi_{0.5}Mn_{1.5}O₄, and sulfur. When the pre-lithiated cathode material is used in combination with another active cathode material, the mass ratio of the pre-lithiated material to the other, e.g., conventional, material may range from about 99:1 to about 10:90 depending on the application requirements. Alternatively, the mass ratio for pre-lithiated material to the conventional or other active material is greater than 100:0 and less than or equal to 10:90; alternatively, between about 90:10 and 20:80; alternatively, in the range of about 80:20 to about 30:70; alternatively, 70:30 to 40:60; alternatively, about 60:40 to about 50:50; alternatively between greater than 100:0 and less than or equal to 51:49.

The preparation of the pre-lithiated active cathode material may be performed in solution by exposing a commercially available compound, such as without limitation LiMn₂O₄, to a relatively mild reducing reagent. This reducing reagent may include, without limitation butyllithium (e.g., n-BuLi, tert-BuLi), lithium naphthalene, or lithium iodide. Butyllithium is known to be very reactive when exposed to air and may pose a fire risk. In order to reduce the risk of creating a fire, the use of a more mild reducing reagent, e.g., lithium naphthalene or the like, is preferable for use in the pre-lithiation of the active cathode material. An organic solution of lithium naphthalene does not generate a significant amount of heat nor pose a fire risk when exposed to air, which makes the production process for the pre-lithiated active cathode material more economical than a process that uses butyllithium. The lithium naphthalene may have a reduction potential at about 0.5 V vs. Li/Li+, which is not stable in air since moisture may be reduced at this potential. In order to enhance stability in air, it is possible to use a pre-lithiation reagent that has relatively high reduction potential, but still low enough to reduce Mn⁴⁺ to Mn³⁺ in LiMn₂O₄. Lithium iodide represents an example, without limitation, of one such pre-lithiation reagent that is stable in air, but also can reduce LiMn₂O₄ into Li₁₊ₓMn₂O₄. In general, a reduction potential about 0.3 V to 2.8 V vs. Li/Li⁺ is preferred for the pre-lithiation reagent.

The 1^{st} cycle CE of an “anode-free” cell using these pre-lithiated cathode active materials may be <90%; alternatively, <80%; alternatively, <70%; and alternatively, <60% as controlled the amount of the lithium incorporated into the active cathode materials via the use of the pre-lithiation step. In this case, a lower 1^{st} cycle CE, corresponds to an increase in the amount of lithium added or deposited within the structure of the active cathode material.

The electrolyte may be any non-flammable electrolyte. Alternatively, the electrolyte may be a liquid electrolyte comprising non-flammable organic solvents such as organic electrolytes with a high concentration of a lithium salt dissolved therein. The electrolyte may also be a polymeric or gel electrolyte such as, without limitation, polyethylene oxide (PEO), polyvinylidene fluoride (PVDF) or a mixture thereof with a lithium salt dissolved therein. The electrolyte may also be an inorganic electrolyte, including but not limited to, a ceramic oxide, glass, or a sulfide electrolyte.

Several specific examples of lithium salts, include, without limitation, lithium hexafluorophosphate (LiPF₆), lithium bis(oxalato)-borate (LiBOB), and lithium bis(trifluoro methane sulfonyl)imide (LiTFSi). These lithium salts may form a solution with an organic solvent, such as, for example, ethylene carbonate (EC), ethyl methyl carbonate (EMC), diethyl carbonate (DEC), dimethyl carbonate (DMC), propylene carbonate (PC), vinylene carbonate (VC), and fluoroethylene carbonate (FEC), to name a few. A specific example of an electrolyte is a 1 molar solution of LiPF₆ in a mixture of ethylene carbonate and diethyl carbonate (EC/DEC=50/50 vol.).

Referring again to FIGS. 1A and 1B, the electrolyte 30 is positioned between and in contact with the negative electrode 20 and the positive electrode 10, such that the electrolyte 30 supports a reversible flow of lithium ions between the positive electrode 10 and the negative electrode 20. The separator 25 is configured to electrically isolate the positive electrode 10 from the negative electrode 20, while being permeable to the reversible flow of the lithium ions there through.

According to yet another aspect of the present disclosure, one or more of the anode-free electrochemical cells may be combined to form a larger capacity battery or battery pack, such as a lithium-ion secondary battery used in an electric vehicle (EV). The one or more electrochemical cells may be incorporated in series, in parallel, or in a combination thereof in order to form the battery or battery pack. One skilled in the art will also appreciate that in addition to using the “anode-free” cells in a lithium-ion secondary battery, the same principles may be used to encompass or encase one or more electrochemical cells into a housing for use in another application.

The housing may be constructed of any material known for such use in the art and be of any desired geometry required or desired for a specific application. For example, lithium-ion batteries generally are housed in three different main form factors or geometries, namely, cylindrical, prismatic, or soft pouch. The housing for a cylindrical battery may be made of aluminum, steel, or the like. Prismatic batteries generally comprise a housing that is rectangular shaped rather than cylindrical. Soft pouch housings may be made in a variety of shapes and sizes. These soft housings may be comprised of an aluminum foil pouch coated with a plastic on the inside, outside, or both. The soft housing may also be a polymeric-type encasing. The polymer composition used for the housing may be any known polymeric materials that are conventionally used in lithium-ion secondary batteries. One specific example, among many, include the use of a laminate pouch that comprises a polyolefin layer on the inside and a polyamide layer on the outside. A soft housing needs to be designed such that the housing provides mechanical protection for the “anode-free” cells present in the battery.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### Example 1. Synthesis and Testing of Li_{1.3}Mn₂O₄

A pre-lithiated active cathode material having the composition of Li_{1.3}Mn₂O₄ was prepared using a solution process. A total of 0.0576 grams of lithium was dissolved in 20 grams of tetrahydrofuran (THF) with 1.062 grams of naphthalene in an inert atmosphere (e.g., N₂). A clear dark blue solution was obtained within a few hours. Then, 5.0 grams of LiMn₂O₄ was added into the solution with stirring. The dispersion was stirred overnight (e.g., 12-18 hours) while under an inert atmosphere. The dispersion was then removed from under the inert atmosphere and filtered while being exposed to air. The resulting filtered material was rinsed with THF several times. Finally, the rinsed material was dried in a vacuum at room temperature and the dried powder collected.

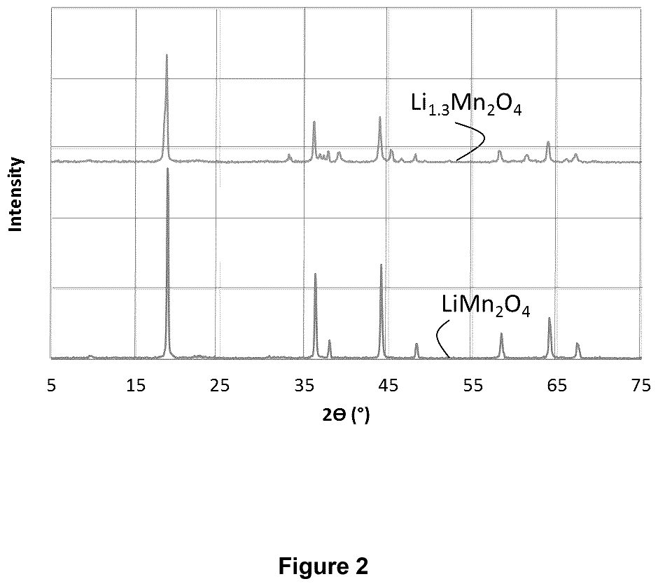

The x-ray diffraction (XRD) patterns for both the pristine LiMn₂O₄ starting material and the as-made pre-lithiated Li_{1.3}Mn₂O₄ are shown in FIG. 2. To make the pre-lithiated electrode (EX-1), a composition comprising 97 wt. % of the pre-lithiated active cathode material, Li_{1.3}Mn₂O₄, 1.5 wt. % carbon nanotubes (CNT), and 1.5 wt. % polyvinylidene fluoride (PVDF) was coated onto an Aluminum foil and calendared. A similar electrode was prepared using pristine LiMn₂O₄ in place of the pre-lithiated active cathode material for use as a reference electrode (REF-1).

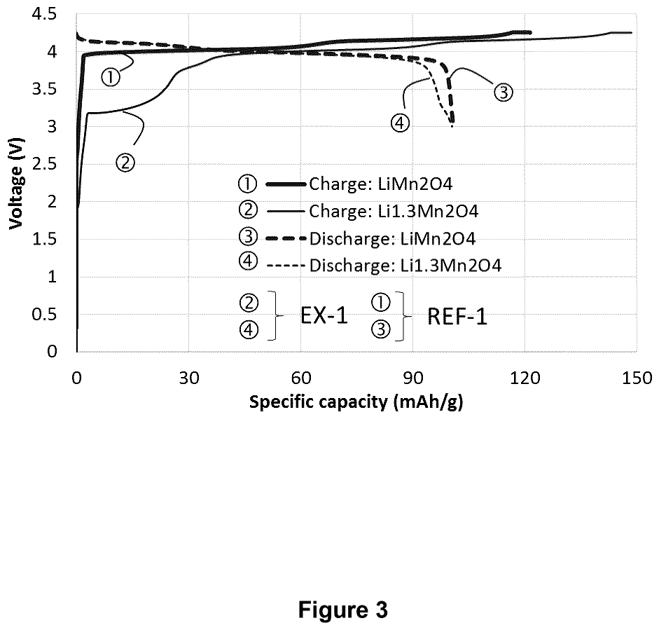

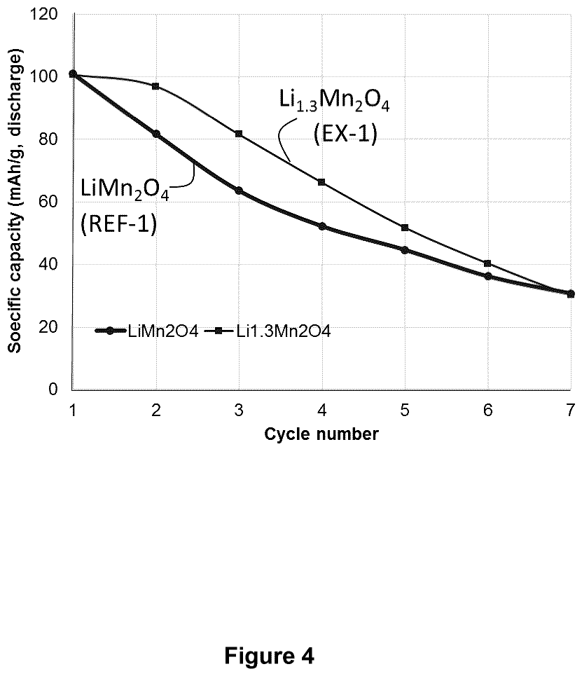

Each of the electrodes (EX-1 and REF-1) were tested in an “anode-free” single-layer pouch cell against a Cu foil wherein the voltage ranged from 3.0 V to 4.25 V at about C/10. The cell was clamped together with two clips. The charge/discharge curves at the 1st cycle for the cells containing the pre-lithiated electrode (EX-1) and the reference electrode (REF-1) are shown in FIG. 3. A comparison of the cycling stability exhibited by the cells containing the pre-lithiated electrode (EX-1) and the reference electrode (REF-1) are shown in FIG. 4.

Referring now to FIG. 3, the 1^{st} charge/discharge curves of the “anode-free” cells demonstrated that the Coulombic Efficiency (CE) from the cell (EX-1) containing the pre-lithiated Li_{1.3}Mn₂O₄ active cathode material was much smaller than that of the cell containing the pristine LiMn₂O₄ (i.e., 67% vs 83%). In FIG. 3, the specific charge capacity from the Li_{1.3}Mn₂O₄ was about 150 mAh/g, while its discharge capacity was about 100 mAh/g. This resulted in a CE of 100/150=67% for EX-1. As a comparison, the specific charge capacity from the pristine LiMn₂O₄ was 121 mAh/g with the discharge capacity of 100 mAh/g. Thus, the CE of the pristine LiMn₂O₄ in REF-1 was 100/121=83%. The much larger specific charge capacity from Li_{1.3}Mn₂O₄ confirmed that the material was pre-lithiated and released an excess amount of lithium during the 1^{st} charging step. Both materials showed similar discharge specific capacity, thereby, confirming that that the pre-lithiation did not reduce the irreversible capacity. The relatively low CE value for the cell containing the pristine LiMn₂O₄ cathode is an artifact from the electrolyte decomposition that occurs at the anode side with the formation of lithium dendrites during the 1^{st} charging step.

Referring now to FIG. 4, the cycling stability test demonstrates that the capacity retention of the cell containing the pre-lithiated Li_{1.3}Mn₂O₄ active cathode material exhibits greater capacity retention than the cell containing the pristine LiMn₂O₄ active cathode material for at least 7 cycles. This difference between the cells may become much larger provided the cells are clamped with high pressure and/or the electrolyte is replaced with a non-LiPF₆ electrolyte because high pressure is important to restrict the growth of lithium dendrites and non-LiPF₆ salts, such as lithium bis(trifluoromethanesulfonyl)imide (LiTFSi), enhance the cycling life expectancy for lithium metal cells.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A rechargeable electrochemical cell, the cell comprising:
a positive electrode comprising a current collector and a pre-lithiated active cathode material comprising one or more of Li₁₊ₓMn₂O₄, Li₁₊ₓNi_{0.5}Mn_{1.5}O₄, Li₁₊ₓNiO₂, Li₁₊ₓCoO₂, Li₁₊ₓNiₐCo_{b}Mn_{c}Al_{d}O₂, wherein x is in the range of 0.1 to 1.0; a+b+c+d=1; a≥0.5; 0≤b≤0.3; 0≤c≤0.3; and 0≤d≤0.05;
a negative electrode comprising a current collector and an optional material provided that the negative electrode exhibits negligible capacity; and
a non-flammable electrolyte configured to conduct lithium ions.

2. The cell according to claim 1, wherein for the active cathode material x is in the range of 0.1 to 0.7.

3. The cell according to claim 1, wherein for the active cathode material x in the range of 0.3 to 0.5.

4. The cell according toclaim 1, wherein the active cathode material is Li₁₊ₓMn₂O₄.

5. The cell according to claim 1, wherein the positive electrode further comprises an additional active cathode material, such that the mixture of the pre-lithiated active cathode material and the additional active cathode material is in a mass ratio that ranges from greater than 100:0 up to less than or equal to 10:90.

6. The cell according to claim 5, wherein the mass ratio of the mixture of the pre-lithiated active cathode material and the additional active cathode material is in a mass ratio that ranges from greater than 100:0 to 51:49.

7. The cell according to claim 1, wherein at least one of the following is present:
the material of the current collector in the negative electrode comprises Cu, Fe, Ni, or a mixture or alloy thereof;
the current collector of one or more of the positive and negative electrodes includes silver, zinc, aluminum, gallium, or a combination thereof; or
the current collector of one or more of the positive and negative electrodes includes at least one metal that can form an alloy with lithium.

8. (canceled)

9. The cell according to claim 1, wherein the negative electrode includes the optional material; the optional material comprising a carbonaceous material in which the negligible capacity is defined as being a reversible capacity ratio between the optional material and the pre-lithiated active cathode material being ≤0.1.

10. (canceled)

11. The cell according to claim 1, wherein the electrolyte is a non-flammable organic electrolyte, a polymeric or gel electrolyte, an inorganic electrolyte, or a combination thereof.

12. The cell according to claim 11, wherein the electrolyte is a non-flammable gel electrolyte.

13. The cell according to claim 1, wherein the cell has an areal reversible cathode capacity loading ≥3.0 mAh/cm².

14. The cell according to claim 13, wherein the cell has an areal reversible cathode capacity loading ≥4.5 mAh/cm².

15. A battery pack for use in an electric vehicle, the battery pack comprising a plurality of cells according to claim 1, wherein the plurality of cells are a placed in series or in a parallel configuration in order to increase overall capacity.

16. A rechargeable electrochemical cell, the cell comprising:
a positive electrode that includes a current collector, a pre-lithiated active cathode material according to the formula F-1 of Li₁₊ₓMn₂O₄, wherein x is in the range of 0.1 to 1.0, and an optional additional active cathode material;
a negative electrode that includes a current collector and an optional carbonaceous material that exhibits a negligible capacity, wherein negligible capacity is defined as being a reversible capacity ratio between the carbonaceous material and the pre-lithiated active cathode material of ≤0.1.; and
a non-flammable organic electrolyte, a polymeric or gel electrolyte, an inorganic electrolyte, or a combination thereof that is configured to conduct lithium ions.

17. The cell according to claim 16, wherein the pre-lithiated active cathode material and the additional active cathode material is in a mass ratio that ranges from greater than 100:0 up to less than or equal to 10:90.

18. The cell according to claim 16, wherein the additional active cathode material is LiMn₂O₄.

19. The cell according to claim 16, wherein the current collector of one or more of the positive and negative electrodes includes at least one metal that can form an alloy with lithium.

20. The cell according to claim 16, wherein the cell has an areal reversible cathode capacity loading ≥3.0 mAh/cm².

21. The cell according to claim 16, wherein the Li₁₊ₓMn₂O₄ is prepared by lithiating LiMn₂O₄ in an organic solvent with a pre-lithiation reagent.

22. The cell according to claim 21, wherein at least one of the following is present:
the pre-lithiation reagent is lithium naphthalene or lithium iodide;
the pre-lithiation reagent has a reduction potential in the range of 0.3 V to 2.8 V vs. Li/Li+.

23. (canceled)
